(19) United States
(12) Patent Application Publication
(10) Pub. No.: US 2011/0030161 A1
(43) Pub. Date: Feb. 10, 2011

(54) PAINT ROLLER AND PAINT ROLLER SLEEVE SUPPORT

(75) Inventors: Christopher Robert Gurr, Sheffield (GB); Andy Linton, York (GB); Andrew Bond, Sheffield (GB)

Correspondence Address: GIFFORD, KRASS, SPRINKLE,ANDERSON & CITKOWSKI, P.C, PO BOX 7021, TROY, MI, 48007-7021, US

(73) Assignee: L G HARRIS & CO LIMITED, Bromsgrove, Worcestershire (GB)

(21) Appl. No.: 12/064,041

(22) PCT Filed: Oct. 30, 2007
(86) PCT No.: PCT/GB2007/004134

§ 371 Date: Oct. 26, 2010

(30) Foreign Application Priority Data
Oct. 30, 2006 (GB) 0621549.5

(51) Int. Cl. B05C 17/02

(52) U.S. Cl. 15/230.11

(57) ABSTRACT

The present invention concerns a paint roller comprising a frame having a handle portion and a shaft, a sleeve support rotatably mounted on the shaft for receiving a roller sleeve, and a locking mechanism moveable between a first position in which a paint roller sleeve can be slid over the said support and a second position in which a part of the mechanism is urged against the inside wall of a roller sleeve mounted on the said support in use, whereby to lock the roller sleeve to the frame. The locking mechanism preferably comprises at least one locking element, preferably a resilient element, and first and second axially movable parts which are movable relative to each other to cause the locking element to be urged outwards against the inside wall of a roller sleeve mounted on the support.

The present invention relates generally to a paint rollers and in particular concerns improvements relating to a paint roller sleeve support having means for holding a removable paint roller sleeve in position on a roller.

It is known, for example from U.S. Pat. No. 5,490,303, U.S. Pat. No. 5,806,129 and U.S. Pat. No. 6,438,788, to provide a paint roller having a paint roller sleeve support in the form of a metal or plastic cage rotatably mounted on a shaft part of the roller frame. The cage is adapted to receive a tubular paint roller sleeve. A roller sleeve can be removably mounted on the cage by the action of urging the sleeve axially over the cage to radially compress the cage. The resilience of the cage holds the cage against the inner surface of the tubular sleeve. The resilience of the cage holds the sleeve on the roller during normal use and allows the sleeve to be removed from the roller when desired.

A problem encountered with the above type of paint roller is know as walk-off, that is the tendency of the sleeve to remove itself from the cage by gradual and incremental axial movement of the sleeve on the cage due to the force applied to the roller and sleeve during painting.

There is a requirement therefore for an improved paint roller which reduces the tendency of a roller sleeve to move axially with respect to the roller sleeve support.

In this respect the present invention seeks to address problems associated with known paint rollers, in particular the problem of roller ‘walk-off’.

According to the present invention there is provided a paint roller comprising a frame having a handle portion and a shaft, sleeve support rotatably mounted on the shaft for receiving a roller sleeve, and a locking mechanism moveable between a first position in which a paint roller sleeve can be slid over the said support and a second position in which a part of the mechanism is urged against the inside wall of a roller sleeve mounted on the said support in use, whereby to lock the roller sleeve to the frame.

Therefore, unlike cage-based systems in which the force required to apply the roller sleeve is the same as that required to remove it, the present invention allows the roller sleeve to be slid over the frame substantially unimpeded by the locking mechanism; when the roller sleeve is in position the locking mechanism is activated to hold the roller firmly in position so that it can not easily be removed.

The locking mechanism may comprise a locking element, and first and second parts which are movable relative to each other to cause the locking element to be urged against the inside wall of the tubular roller.

Movement of the first and second parts towards each other may cause the locking element to be urged against the inside wall of the roller sleeve. For example, the support may comprise a first part and a second part between which a compressible element is located and squeezed in use to urge it against the inside wall of a roller. In this way the roller is clamped to the support.

One of the first and second parts may be fixed and the other of the first and second parts may be movable. Alternatively, both the first and second parts may be movable, both towards and away from each other, to activate and release a locking element.

The locking mechanism may comprise a locking element the dimensions of which can be changed to move it between a release position in which it is spaced from or arranged so as not substantially to impede movement of the roller sleeve and a locking position in which it is urged against the inside wall of the roller sleeve.

The locking mechanism may comprise an element which, in use, undergoes expansion to urge it against the inside of the roller sleeve. For example, the locking mechanism may comprise a compressible element which, when compressed, bulges in a direction which urges it against the inside of a roller sleeve.

The compressible element may be formed from a thermoplastic elastomer (TPE) material. In one embodiment the compressible element comprises an annular bung.

The compressible element may have a hardness value in the Shore A scale. For example, the compressible element may have a hardness value of approximately 50 Shore A.

The present invention will now be more particularly described, by way of example only, with reference to the accompanying drawings, in which:

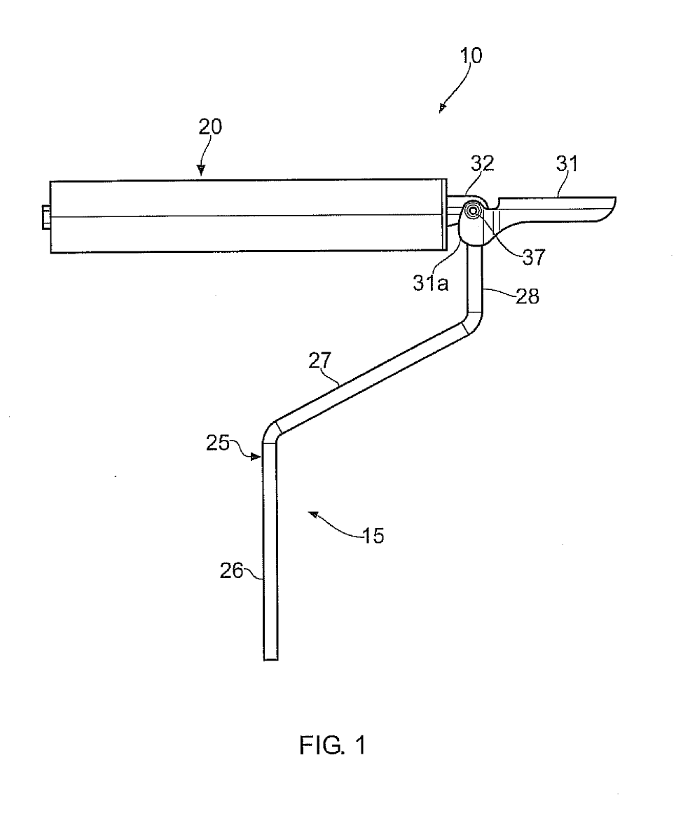

FIG. 1 is a plan view of a paint roller constructed according to an embodiment of the present invention and fitted with a paint roller sleeve;

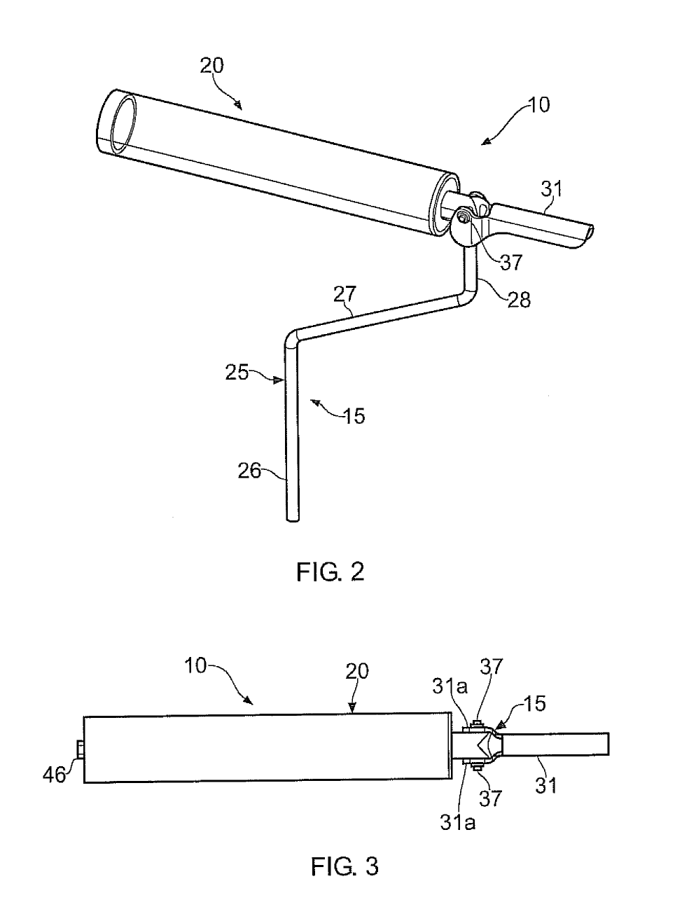

FIG. 2 is a perspective view of the paint roller shown in FIG. 1;

FIG. 3 is an end view from above, in the direction indicated “III”, of the paint roller of FIGS. 1 and 2;

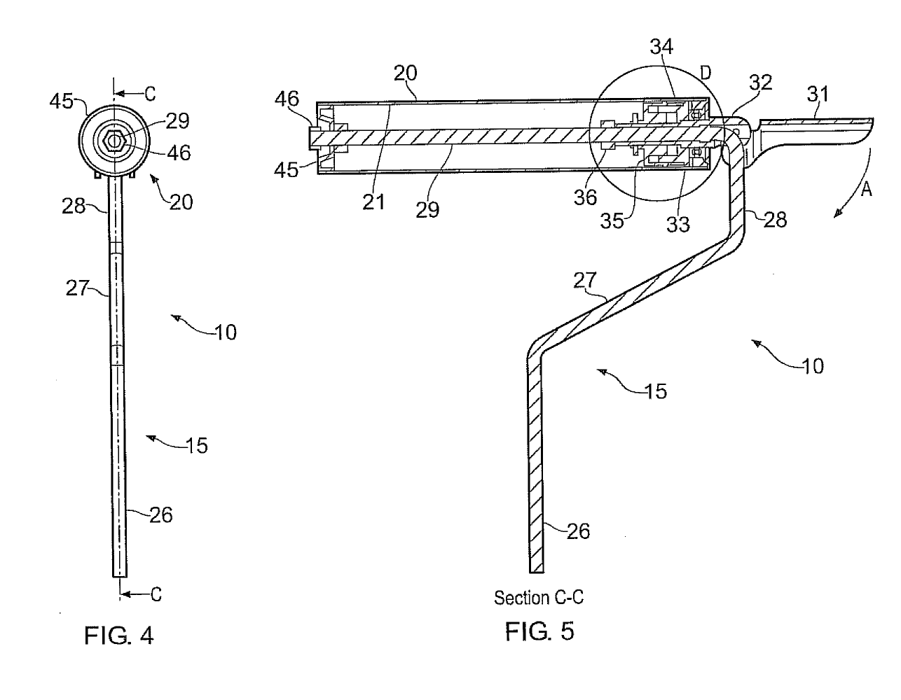

FIG. 4 is a side view of the paint roller of FIGS. 1 to 3;

FIG. 5 is a cross-section view of the paint roller of FIG. 4 taken along line C-C;

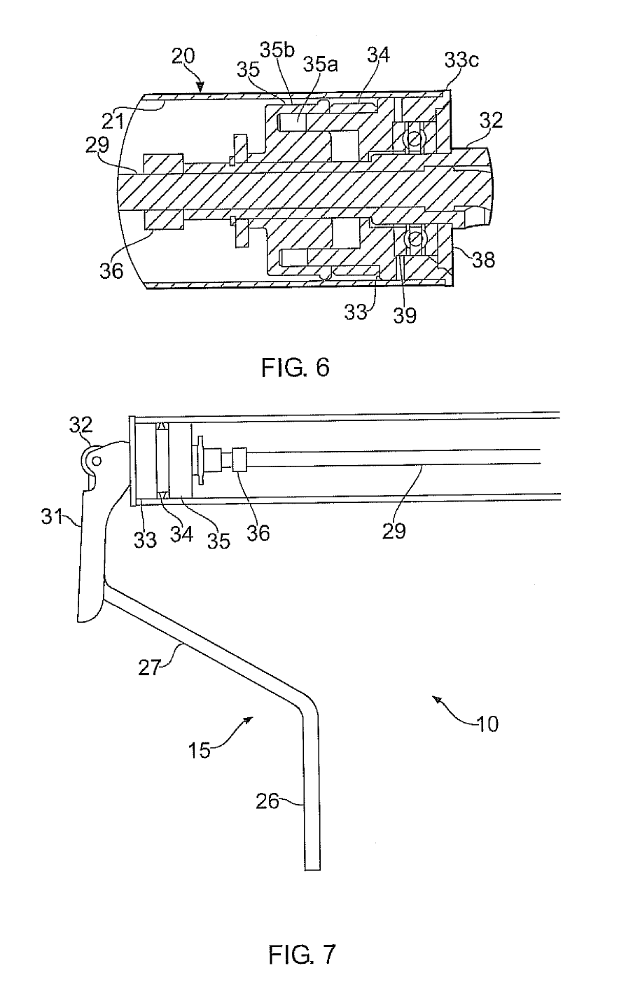

FIG. 6 is a magnified view of the circled region D of FIG. 5;

FIG. 7 is a schematic plan view of the paint roller of FIGS. 1 to 6 shown in a locked position;

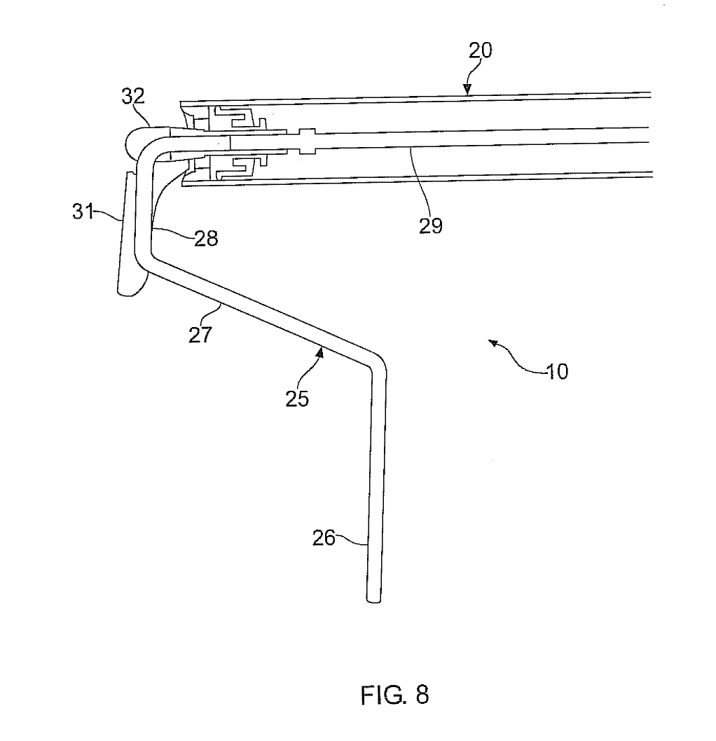

FIG. 8 is a cross-section view of the paint roller of FIG. 7;

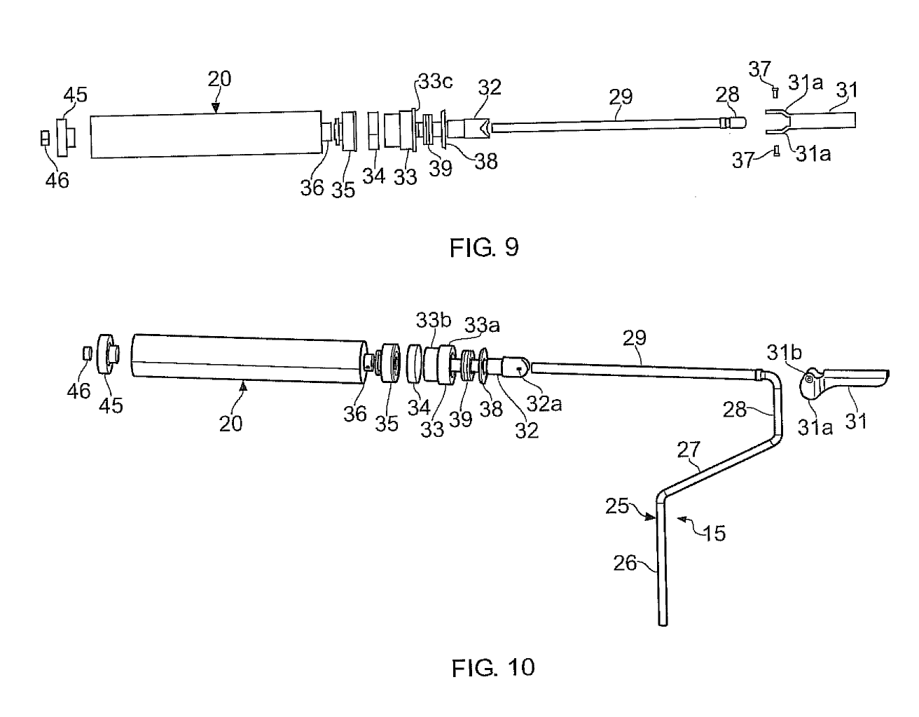

FIG. 9 is an exploded view of the paint roller of FIGS. 1 to 6 shown in the same direction as that of FIG. 3;

FIG. 10 is an exploded view of the paint roller of FIGS. 1 to 6 shown in the same direction as that of FIG. 2;

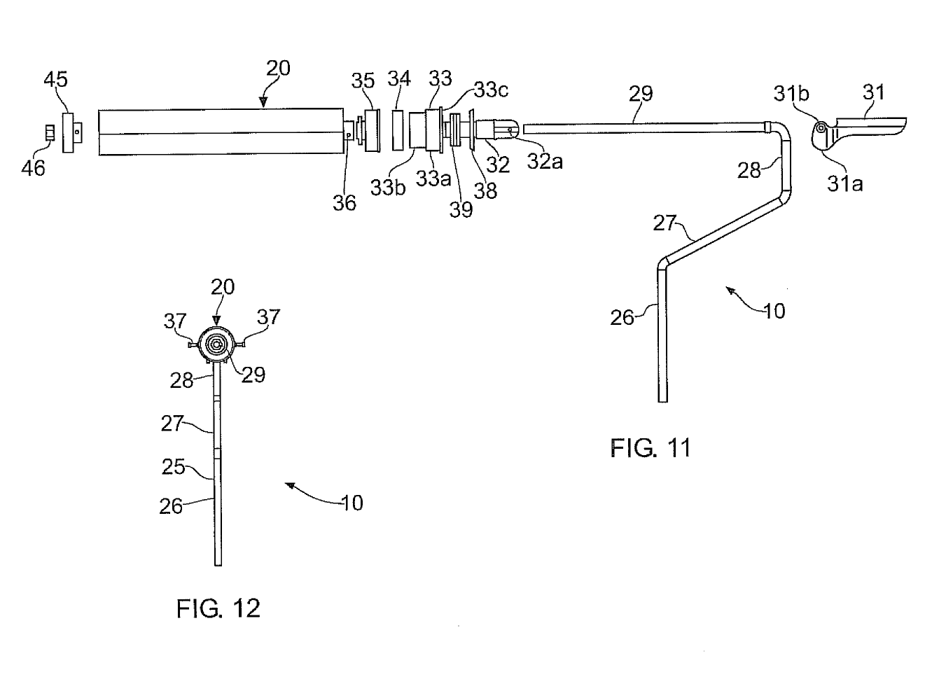

FIG. 11 is an exploded view of the paint roller of FIGS. 1 to 6 shown in the same direction as that of FIG. 1;

FIG. 12 is a side view of the paint roller similar to that shown in FIG. 4;

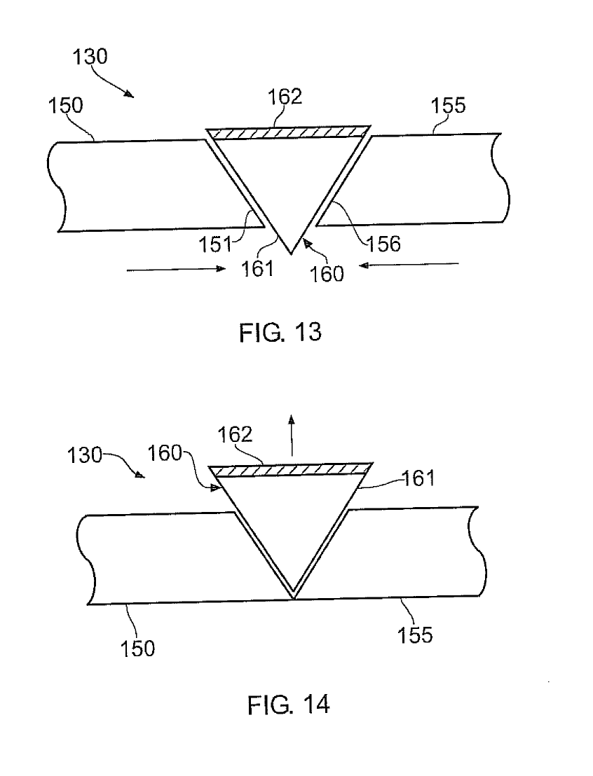

FIG. 13 is a cross-section view of a locking mechanism for a paint roller according to an alternative embodiment with the locking mechanism shown in an unlocked position; and

FIG. 14 is a cross-section of the locking mechanism shown in FIG. 13 shown in a locked position.

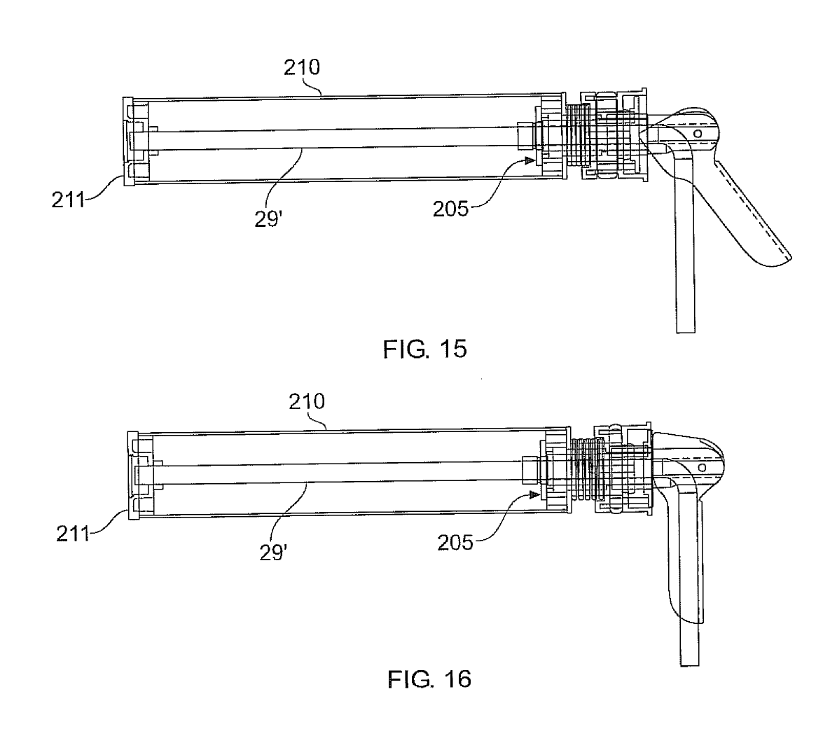

FIG. 15 is a cross-section schematic view of a paint roller according to another embodiment of the invention, having a locking mechanism shown in an unlocked position;

FIG. 16 is a cross-section schematic view of a paint roller according to another embodiment of the invention, having a locking mechanism shown in a locked position.

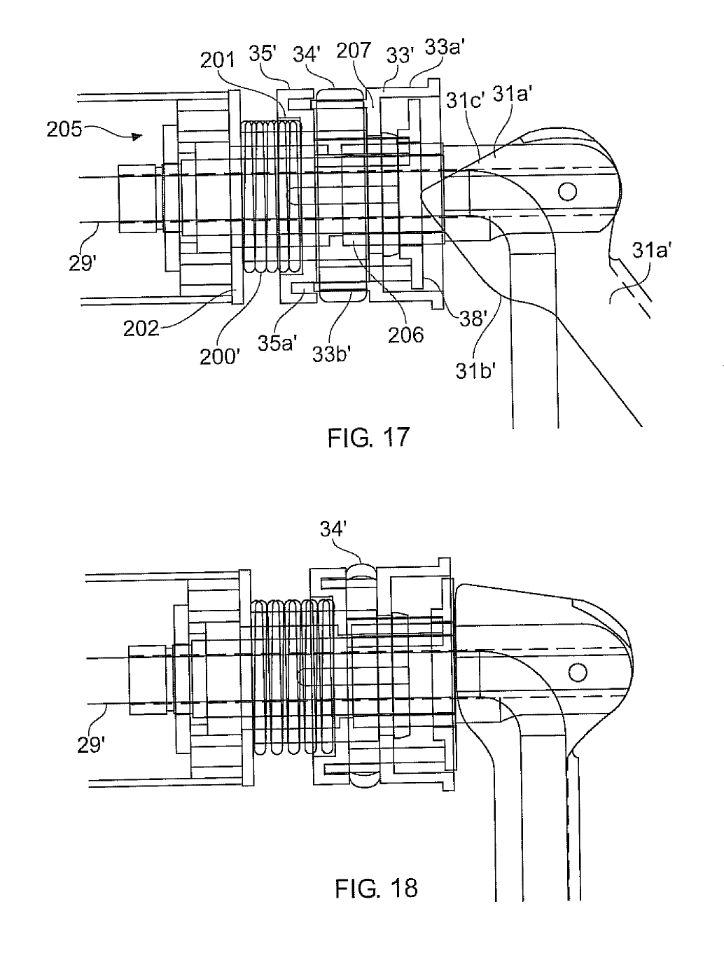

FIG. 17 is an enlarged detailed view of the locking mechanism shown in FIG. 15, in the unlocked position.

FIG. 18 is an enlarged detailed view of the locking mechanism shown in FIG. 16 in the locked position;

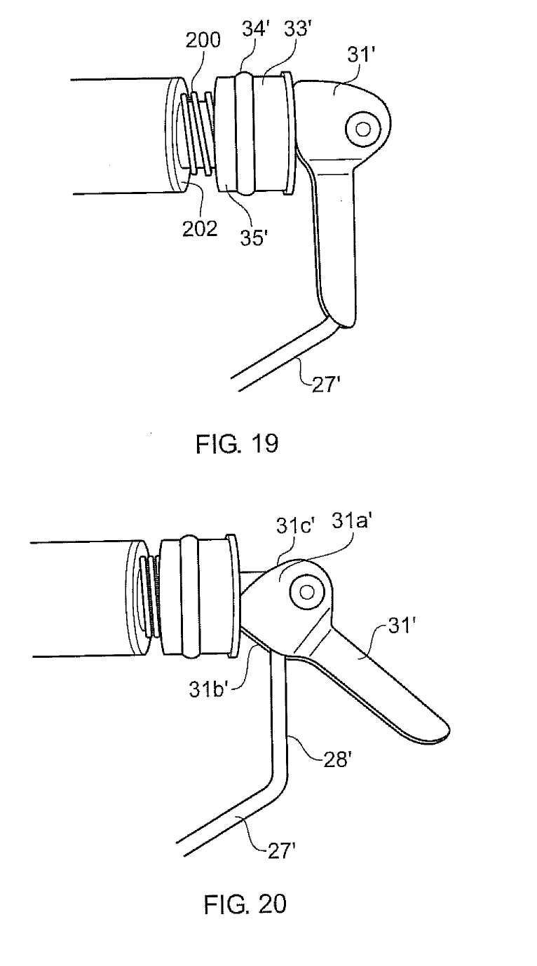

FIG. 19 is a perspective view of the locking mechanism shown in FIGS. 15 to 18 in the locked position; and

FIG. 20 is a perspective view of the locking mechanism shown in FIGS. 15 to 19 in the unlocked position.

Referring first to FIGS. 1 to 4 there is shown a paint roller assembly generally indicated 10. The assembly 10 comprises a paint roller frame 15 and a cylindrical tubular paint roller sleeve 20, only the inner tubular part of which is shown in the drawings herein for clarity, the outer fleece or foam of the roller sleeve which is actually used for applying paint is not shown.

The paint roller frame 15 comprises four sections: a handle 26; an offsetting link 27; a connecting link 28; and a roller shaft 29.

The handle 26 and the link 28 extend parallel to each other with their axes offset by the connecting link 27 which is angled with respect to the two parts 26 and 28. The roller shaft 29 extends transversely from the end of the link 28 opposite the end adjoining the link 27.

The tubular roller sleeve 20 is hollow and is rotatably received on the roller shaft 29. The roller 20 is retained on the shaft 29 by a locking mechanism 30 as shown best in FIGS. 5 to 11.

The locking mechanism 30 includes: a lever 31; a plunger 32; a fixed clamping member 33; an annular compressible bung 34; a movable clamping member 35; and a stop member 36.

The plunger 32 is received over the shaft 29 to the position shown best in FIG. 5. As can best be seen in FIGS. 9 and 10, the plunger 32 includes a pinhole 32a and the lever 31 includes two plates 31a each having a pinhole 31b. The lever 31 is presented to the roller frame so that the plates 31a sit either side of the curved intersection between the link 28 and the shaft 29. In this position the holes 31b are in registration with the hole 32a and the lever 31 is pivotally secured to the plunger 32 by two pins 37.

A disc-shape end plate 38 is slid over the plunger 32 until it abuts against a shoulder 32b on the external outer surface of the plunger.

A washer 39 is slid over the plunger 32 until it abuts against the end plate 38.

The fixed part 33, which has a generally circular cylindrical configuration, is slid over the plunger 32 until it abuts against the end plate 38.

The part 33 comprises a first annulus 33a and a step 33d which defines a concentric second annulus 33b having a smaller diameter than the first. The end of the first annulus 33a remote from the step 33d comprises a radially outwardly extending flange 33c and an inward step 33e, best seen in FIG. 6.

The fixed clamping part 33 is received onto the plunger 32 so that the stepped flange 33c abuts against the end plate 38. The washer 39 is received in the region between the annulus 33a, the plunger 32 and the end plate 38 to hold the part 33 axially in position.

The annular resilient bung 34 fits onto the outer surface of the second annulus 33b of the part 33, where it abuts against the step 33d.

The movable part 35 fits onto the plunger 32 and is fixed thereto. The axially extending annulus 33b of the part 33 is received in an axially extending annular recess 35a formed radially inwardly of an annular outer skirt 35b of the movable clamping part 35. This allows the part 35 to be moved relative to the part 33 along the shaft 29 as described in more detail below, by telescopic movement of the cooperating telescopically mounted parts 33 and 35.

The stop member 36 is positioned on the shaft 29 so that the plunger 32 abuts against it when the locking mechanism 30 is in the unlocked position as shown in FIGS. 1 to 6.

In use, a paint roller sleeve 20 is received over the shaft 29 so that one end abuts against the flange 33c on the fixed clamping part 33, as best shown in FIG. 6.

In the position shown in FIG. 5 the movable clamping part 35 and the fixed part 33 are at a maximum axial separation. In this position the bung 34 is relaxed and in this state does not contact the inner tubular wall 21 of the roller sleeve 20. The plunger 32 abuts against the stop member 36.

If the lever 31 is pivoted in the direction A about the pivot point formed at the connection between it and the plunger 32, the plunger 32 is caused to be withdrawn away from the stop member 36. The plates 31a of the lever 31 engage the plate 38 and this provides a camming action as the lever 31 is rotated which provides the force to withdraw the plunger 32. The plunger 32 is withdrawn through the fixed part 33, the washer 39 and the end plate 38. In this respect it will be seen that the end of the lever adjacent the pins 37 has an eccentric cam profile which provides a cam surface for engagement with the end face of the end plate 38.

Because the movable part 35 is fixed to the plunger 32 it is pulled towards the fixed part 33 so that the annulus 33b enters the recess 35a; this causes compression of the hung 34. In turn, the effective circumference of the bung 34 increases as it is compressed, that is to say the resilient annular bung is deformed so that its outer diameter increases. This causes the bung 34 to be forced against the inside wall 21 of the roller 20, as shown in FIGS. 7 and 8, to clamp itself against the roller sleeve.

At the opposite end of the roller 20, an end plate 45 is provided. The plate 45 is rotatably received on the shaft 29 and fixed onto the internal bore of the roller 20. A nut 46 is provided to secure the plate 45 in position. This part of the roller does not form part of the locking mechanism as such.

In order to remove the roller 20 from the frame 15, the lever is pivoted back up to the position shown in FIGS. 1 to 5 so that the plunger is moved towards the stop member 36. Accordingly, the movable member 35 is moved away from the fixed member 33 and the compression forces on the bung 34 are released so that it returns to its undistorted shape to the position shown in FIGS. 5 and 6 where it is not in contact with or urged against the inside wall 21 of the roller sleeve.

Referring now to FIGS. 13 and 14 there is shown an alternative locking mechanism 130. The mechanism 130 comprises two clamping members 150, 155 which can be moved towards and away from each other.

The members 150, 155 terminate with oppositely inclined abutment faces 151, 156 between which is received a locking element 160 with a generally triangular section. The element 160 includes a main body 161 formed from a rigid material and a crown 162 formed from a compressible material with a high co-efficient of friction.

In use, if the clamping members 150, 155 are moved towards each other the element 160 is caused to move to the position shown in FIG. 14. In this way, the crown 162 could be urged against the inside wall (not shown) of a tubular paint roller.

A further embodiment of the present invention will now be described with reference to FIGS. 15 to 20 which show a paint roller with a locking mechanism similar to that of the first embodiment but modified in certain aspects as will be further described. For the purpose of describing the embodiment shown in FIGS. 15 to 20 the same reference numerals as used previously will be used in the following description, where appropriate, to refer to the same or similar components, however the reference numerals will be accompanied by a further indication to indicate similar parts in the following description of FIGS. 15 to 20.

In the drawings of FIGS. 15 to 20 only the paint roller itself is shown. The paint roller sleeve 20 illustrated in the previous embodiments is not shown in these drawings. In addition, only part of the frame comprising the link 28′ and shaft part 29′ is shown in the drawings of FIGS. 15 to 18, with part of the link part 27′ shown in FIGS. 19 and 20.

The locking mechanism of this embodiment will now be more particularly described with reference to the detailed enlarged views of FIGS. 17 and 18. The locking mechanism is similar to that described in the first embodiment in that it comprises a pair of relatively movable annular components including a first part 33′ and a second part 35′ which include cooperating adjacent telescopic ends. Both the first and second parts 33′ and 35′ have a generally circular cylindrical shape with the first part 33′ having a stepped outer cylindrical surface with an increased diameter cylindrical part 33a′ at its end closest to a locking lever 31a′, and a reduced diameter portion 32b′ at the other end thereof. The outer surface of the reduced diameter portion 32b′ accommodates a resilient and compressible annular locking element in the form of an elastomeric ring 34′ which in its relaxed state shown in FIG. 17a has an external diameter the same or similar to that of the outer diameter of the increased diameter portion 33a′. The end of the reduced diameter annular portion 33B is received into a corresponding annular recess 35a′ in the surface of the second part 35′ facing the compressible element 34′. The annular recess 35a′ enables the axially extending annular part 33b′ to be received therein such that the recess 35a′ and annular part 33b′ define cooperating telescopic parts which enables the axial distance between the parts to be varied between the maximum separation shown in FIG. 17, where the locking mechanism is in its unlocked configuration, and the minimum separation between the parts as shown in FIG. 18 where the locking mechanism is shown in the locked configuration.

The end face of the second part 35′ on the opposite side of the second part to that of the recess 35a′ is stepped to provide a spigot type feature 201 for accommodating one end of a coil spring 200. As can be seen, one of the axial ends of the coil spring is located in the spigot 201 and the other end of the spring bears against a disc shape end plate 202 of an end cap, generally indicated 205, rotatably mounted on the roller shaft 29′. A concentric cylindrical part 206 of the end cap 205 extends forward towards the lever 31A through a central aperture in the second part 35′ and forward of an internal radial flange part 207 of the annular part 33a′ to secure the first part 33′ in an annular groove on the radially outer surface of the annular cylindrical extension 206 so that the first part 33 is fixed relative to the end cap 205.

As previously mentioned the locking lever 31a′ is provided with a cam profile end 31′ which comprises two adjoining surfaces 31b′ and 31c′ which are inclined with respect to each other by an amount slightly less than 90°. In the unlocked position of FIG. 17 the apex of the adjoining cam surfaces contacts a facing surface of an annular disc 38′ which is axially movable in the direction of the shaft 29′ between the position shown in FIG. 17 and that in FIG. 18. In the position shown in FIG. 18 the whole or substantially the whole cam surface 31b′ lies flat against the facing surface of the annular disc 38′ when the locking mechanism is in its locked configuration.

The annular disc 38′ is accommodated in the internal hollow annular region of the enlarged diameter part 33a′ and is movable therein under the action of the cam end of the lever 31′ to move the second part 35′ axially along the shaft 29′ against the restoring force of the compression spring 200. As can be seen in the drawing of FIG. 17 when the lever 31′ is moved to its unlocked position the annular disc 38′ is moved axially towards the locking element 34′ so that the second part 35a is moved away from the locking element so that any compressive force acting on the locking element due to the compression spring are relieved so that the resilient locking element assumes its normal shape, as shown in FIG. 17 with the spring compressed. When the lever 31′ is moved to the locked position shown in FIG. 18 the restoring force of the spring is transmitted through the second part 35′ which moves axially towards the first part 33′ and compresses the locking element 34 to cause it to bulge radially outwards as shown in FIG. 18. This action, as previously described, is sufficient to create a clamping force between the resilient element 34′ and the inner surface of the roller sleeve (not shown) that is mounted on the paint roller sleeve support in use.

As can best be seen in the drawings of FIGS. 15 and 16 the paint roller support in this embodiment also includes a tubular circular cylindrical element 210 which extends between the end piece 205 in the region of the locking mechanism and a further end piece 211 at the opposite end of the shaft 29′. The outer surface of the cylinder 210 has the same or substantially the same diameter as the outer surfaces of the respective first and second parts 33′ and 35′ to accommodate a roller sleeve of the same diameter thereon.

Referring to FIGS. 19 and 20 the perspective view of the locking mechanism shows the major components including the lever 31′, the first part 33′, the locking element 34′ and the second part 35′. The compression spring 200 is shown located between the second part 35′ and the end face 202 of the end piece 205.

1. A paint roller comprising a frame having a handle portion and a shaft, a sleeve support rotatably mounted on the shaft for receiving a roller sleeve, and a locking mechanism moveable between a first position in which a paint roller sleeve can be slid over the said support and a second position in which a part of the mechanism is urged against the inside wall of a roller sleeve mounted on the said support in use, whereby to lock the roller sleeve to the frame.

2. A paint roller as claimed in claim 1, in which the locking mechanism comprises at least one locking element, and first and second parts which are movable relative to each other to cause the locking element to be urged against the inside wall of a roller sleeve mounted on the said support.

3. A paint roller as claimed in claim 2, in which the first part is fixed and the second part is movable.

4. A paint roller as claimed in claim 2 wherein the geometry of the said locking element is adjustable so that the geometry can be changed between a release configuration and a locking configuration.

5. A paint roller as claimed in claim 2, in which the locking element comprises a compressible resilient element which, in use, expands to urge it against the inside of the said roller sleeve to clamp the said sleeve on the said sleeve support.

6. A paint roller as claimed in claim 5, in which the compressible element is formed from a thermoplastic elastomer material.

7. A paint roller as claimed in claim 5, in which the compressible element has a Shore A hardness value of 50 Shore.

8. A paint roller as claimed in claim 5, wherein the compressible element comprises an annular element.

9. A paint roller as claimed in claim 8 wherein the compressible annular element is positioned between the said first and second parts so that the element is resiliently deformed by movement of the said first and second parts towards each other, in use, which movement causes the element to expand radially outwards against the inner surface of the said roller sleeve.

10. A part roller as claimed in claim 4 wherein said locking mechanism further comprises cam means for effecting said relative movement of the said first and second parts.

11. A paint roller as claimed in claim 10 wherein said cam means is part of or connected to a lever which is pivotally connected to said roller frame and manually movable between a locked position and a release position to rotate the said cam means.

12. A paint roller as claimed in claim 10 further comprising biasing means for biasing the said first and second parts apart and wherein said cam means acts against said biasing means to alter the separation of the said first and second parts.

13. A paint roller as claimed in claim 12 wherein said biasing means is a spring and said cam means acts against the restoring force of the spring to alter the axial separation of the said first and second parts and thereby the axial compression force acting on the said locking element as the cam means rotates between its locked and release position.

14. A paint roller as claimed in claim 12 wherein the said cam means acts on a plunger means connected to said movable second part for axial movement therewith away from said first part during unlocking and towards said first part during locking movement of the said locking mechanism.
